(19) United States
(12) Patent Application Publication
(10) Pub. No.: US 2012/0194391 A1
(43) Pub. Date: Aug. 2, 2012

(54) MIMO ANTENNA SYSTEM

(76) Inventors: Ming-Yen LIU, Taipei (TW); Hsiao-Ming Tsai, Taipei (TW); Ching-Ming Chen, Taipei (TW); Jung-Huang Chiang, Taipei (TW); Shih-Chieh Chen, Taipei (TW)

(21) Appl. No.: 13/354,948

(22) Filed: Jan. 20, 2012

(30) Foreign Application Priority Data
Feb. 1, 2011 (CN) 201110034412.3

(51) Int. Cl. H01Q 9/04; H01Q 5/00

(52) U.S. Cl. 343/700 MS

(57) ABSTRACT

A multi-input multi-output (MIMO) antenna system includes multiple antennas, a ground part and an isolating part. The isolating part is disposed between each two adjacent antennas. The isolating part is electrically connected to the ground part. A distance exists between an end of the antenna and an end of the isolating part. A circuit board applying the MIMO antenna system is also disclosed. Since the isolating part is disposed between each two adjacent antennas, signal interference between the antennas can be prevented, and the MIMO antenna system and the circuit board applying the same have better isolation.

### CROSS REFERENCE TO RELATED APPLICATIONS

This Non-provisional application claims priority under 35 U.S.C. §119(a) on Patent Application No(s). 201110034412.3 filed in People's Republic of China on Feb. 1, 2011, the entire contents of which are hereby incorporated by reference.

### BACKGROUND OF TILE INVENTION

1. Field of Invention

The invention relates to an antenna system and, more particularly, to a MIMO antenna system.

2. Related Art

As wireless communication technology develops rapidly, varies requirements on type and quality of the wireless communication are raised. In current spectrum resource, MIMO antenna system provides higher communicating speed and reliability.

Each antenna in the MIMO antenna system can receive and transmit signals in different frequency, and thus the spectrum utilization ratio is improved greatly, and data transmission rate of the system is increased.

When the MIMO antenna system is disposed in an electronic device, each one of the multiple antennas may be disposed very close to each other. Thus, the signal between each two adjacent antennas may be interfered, and the transmission speed and quality of the MIMO antenna system is affected.

### SUMMARY OF THE INVENTION

A MIMO antenna system with better isolation is disclosed.

A MIMO antenna system includes multiple antennas, a ground part and an isolating part. The isolating part is disposed between each two adjacent antennas. The isolating part is made of conductive material and is electrically connected to the ground part.

A circuit board applying a MIMO antenna system includes a chip and a MIMO antenna system. The MIMO antenna system includes multiple antennas, a ground part and an isolating part. The isolating part is disposed between each two adjacent antennas. The isolating part is made of conductive material and electrically connected to the ground part.

Since the isolating part is disposed between each two adjacent antennas and isolates the signal interference, the MIMO antenna system and the circuit board applying the same have better performance in an appropriate isolation. The shape of the antennas in the MIMO antenna system is not limited, and the shape and size of the isolating part can be adjusted accordingly, which is flexible and useful in manufacture.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a circuit board applying a MIMO antenna system in an embodiment;

FIG. 2 is a schematic diagram showing a MIMO antenna system in a first embodiment;

FIG. 3 is a schematic diagram showing a MIMO antenna system in a second embodiment;

FIG. 4a to FIG. 4h are schematic diagrams showing isolating parts in different shapes in embodiments; and

FIG. 5a to FIG. 5f are schematic diagrams showing antennas in different shapes in embodiments.

### DETAILED DESCRIPTION OF THE INVENTION

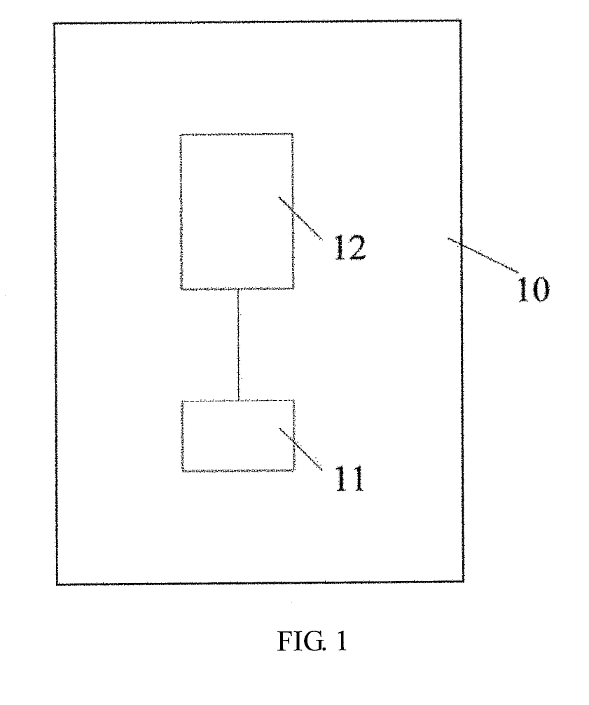

FIG. 1 is a schematic diagram showing a circuit board applying a MIMO antenna system in an embodiment.

A circuit board 10 includes a chip 11 and a MIMO antenna system 12. The circuit board 10 can be applied to an electronic device such as a computer, a mobile phone or a wireless hub which needs an antenna system. The circuit board 10 may also include other electrical components, which is omitted herein.

A feed-in end of the MIMO antenna system 12 is electrically connected to the chip 11 to transmit signals therebetween. The MIMO antenna system 12 may be printed at the circuit board 10 or be made into a metal sheet and attached to the circuit board 10, which is not limited herein.

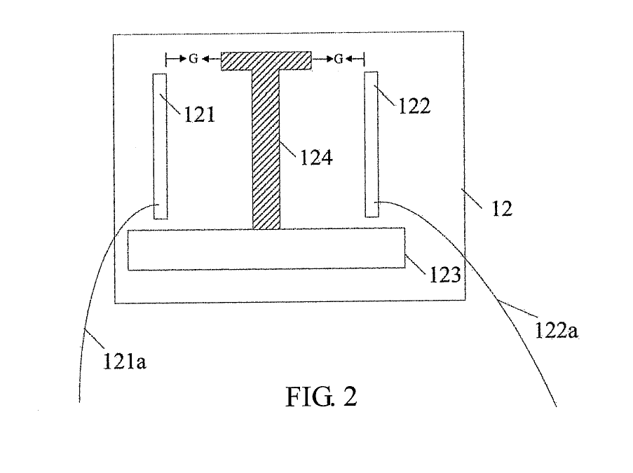

FIG. 2 is a schematic diagram showing a MIMO antenna system in a first embodiment.

A MIMO antenna system 12 includes a first antenna 121, a second antenna 122, a ground part 123 and an isolating part 124.

The first antenna 121 and the second antenna 122 may be single-frequency antennas or multi-frequency antennas. In the embodiment, the first antenna 121 and the second antenna 122 are single-frequency antennas as an example. The first antenna 121 includes a first feed-in end 121a connecting the first antenna 121 and the chip (as shown in FIG. 1). The second antenna 122 includes a second feed-in end 122a connecting the second antenna 122 and the chip (as shown in FIG. 1).

The isolating part 124 is disposed between the first antenna 121 and the second antenna 122. The isolating part 124 is made of conductive material and electrically connected to the ground part 123. The ground part 123 is connected to the ground and keeps the isolating part 124 at zero potential.

The shape and the size of the isolating part 124 can be determined according to the radiating length of the first antenna 121 and that of the second antenna 122 in the operation band and requirements on the antenna size.

In the embodiment, the isolating part 124 is in a T-shape, its length approximately equals to the length of the first antenna 121 or that of the second antenna 122, and a distance G exists between one end of the antenna and one end of the isolating part to isolate the signal interference between the first antenna 121 and the second antenna 122.

After the shape of the isolating part 124 is determined, the length and the width of the isolating part can be determined by limit tests, and therefore is omitted herein.

When the MIMO antenna system 12 includes more than two antennas, multiple isolating parts may be disposed between each two adjacent antennas.

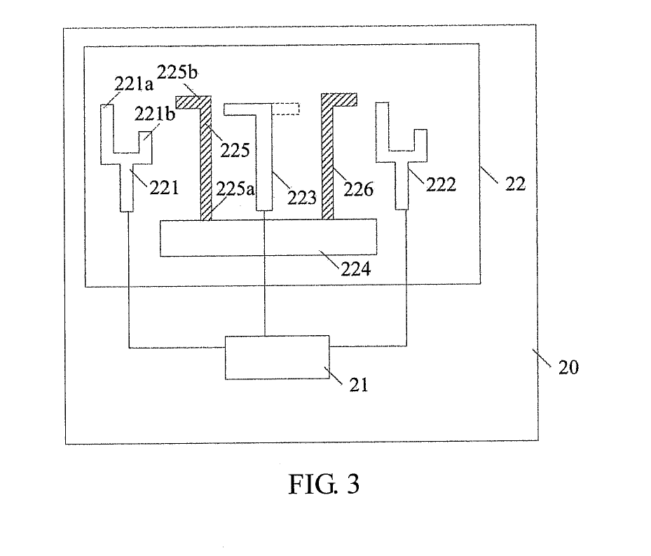

FIG. 3 is a schematic diagram showing a MIMO antenna system in a second embodiment.

The circuit board 20 includes a chip 21 and a MIMO antenna system 22. The MIMO antenna system 22 is electrically connected to the chip 21 to transmit signals therebetween.

The MIMO antenna system 12 includes a first antenna 221, a second antenna 222, a third antenna 223, a ground part 224, a first isolating part 225 and a second isolating part 226.

In the embodiment, the first antenna 221, the second antenna 222 and the third antenna 223 are dual frequency antennas. Taking the first antenna 221 as an example, it includes a high frequency part 221a and a low frequency part 221b to transmit signals in different frequencies. The first antenna 221, the second antenna 222 and the third antenna 223 include feed-in ends, respectively, to be electrically connected to the chip 21.

The first isolating part 225 and the second isolating part 226 are disposed between each two adjacent antennas, respectively, and keep a distance between adjacent antennas to prevent signal interference.

In the embodiment, the first isolating part 225 and the second isolating part 226 are in an inverted L-shape. Taking the first isolating part 225 as an example, the first isolating part 225 includes a first side 225a and a second side 225b. The first side 225a is closed to and electrically connected to the ground part 224, and the second side 225b is away from the first side 225a, and its width is larger than the width of the first side 225a.

The shape and size of the first isolating part 225 and the second isolating part 226 can be determined according to the radiating length of the first antenna 221, the second antenna 222 and the third antenna 223 in the operation band and requirements of the antenna size.

The shape and the size of antennas and isolating parts are not limited herein.

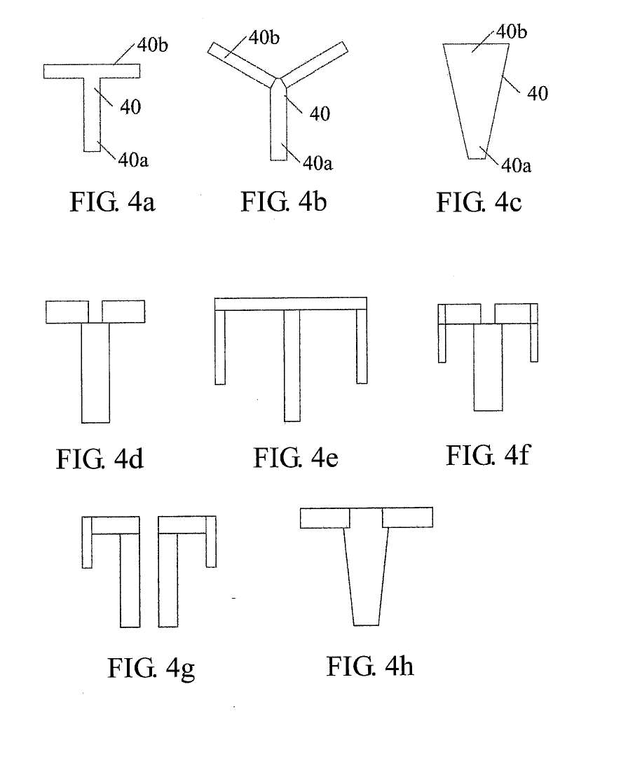

FIG. 4a to FIG. 4h are schematic diagrams showing isolating parts in different shapes in embodiments.

In order to decrease the signal interference between the antennas, the isolating parts may have different shapes.

For example, the isolating part 40 in FIG. 4a includes a first side 40a and a second side 40b, as shown in FIG. 2. The first side 40a is closed to and electrically connected to the ground part 123 (as shown in FIG. 2). The second side 40b is away from the first side 40a, and the width of the second side 40b is larger than the width of the first side 40a. The isolating part 40 is T-shaped, and thus it can effectively prevent the signal of the antenna from transmitting across the isolating part 40.

The isolating part 40 in FIG. 4b is Y-shaped. The first side 40a is electrically connected to the ground part 123 (as shown in FIG. 2), and the second side 40b is away from the first side 40a, and the width of the second side 40b is larger than the width of the first side 40a.

The isolating part 40 in FIG. 4c is an inverted trapezoid in shape. The first side 40a is electrically connected to the ground part 123 (as shown in FIG. 2), and the second side 40b is away from the first side 40a, and the width of the second side 40b is larger than the width of the first side 40a.

In FIG. 4d to FIG. 4h, it also shows that the second side 40b of the isolating part 40 away from the ground part 123 has a larger width than the first side 40a connected to the ground part 123. The isolating parts 40 in different shapes can effectively prevent the signal of the antenna from transmitting across the isolating part 40 and improve the isolation of the MIMO antenna system.

The isolating part 40 may also be a bar in shape.

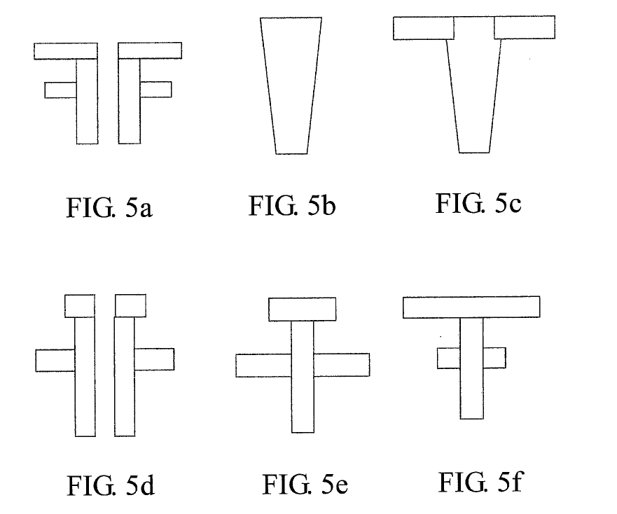

FIG. 5a to FIG. 5f are schematic diagrams showing antennas in different shapes.

The antenna may also be double F-shaped as shown in FIG. 5a, inverted trapezoid-shaped as shown in FIG. 5b or T-shaped as shown in FIG. 5c, which is not limited herein.

In sum, the isolating part is disposed between each two adjacent antennas and isolates the signal interference, the MIMO antenna system and the circuit board applying the same have a better performance in an appropriate isolation.

One side of the isolating part away from the ground part has a larger width than the other side close to the ground part, so as to prevent the signal of the antenna from transmitting across the isolating part.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A multi-input multi-output (MIMO) antenna system, comprising:
multiple antennas;
a ground part; and
an isolating part disposed between each two adjacent antennas and electrically connected to the ground part;
wherein a distance exists between an end of the antenna and an end of the isolating part.

2. The MIMO antenna system according to claim 1, wherein the isolating part is a bar in shape.

3. The MIMO antenna system according to claim 1, wherein the isolating part includes:
a first side electrically connected to the ground part;
a second side away from the first side, wherein the width of the second side is larger than the width of the first side.

4. The MIMO antenna system according to claim 1, wherein each of the antennas is a single-frequency antenna or a multi-frequency antenna.

5. A circuit board configured to a multi-input multi-output (MIMO) antenna system, comprising:
a chip; and
a MIMO antenna system, including:
multiple antennas electrically connected to the chip;
a ground part; and
an isolating part disposed between each two adjacent antennas and electrically connected to the ground part.

6. The circuit board according to claim 5, wherein the isolating part is a bar in shape.

7. The circuit board according to claim 5, wherein the isolating part includes:
a first side electrically connected to the ground part;
a second side away from the first side, wherein the width of the second side is larger than the width of the first side.

8. The circuit board according to claim 5, wherein each of the antennas is a single-frequency antenna or a multi-frequency antenna.
